(19) United States
(12) Patent Application Publication
(10) Pub. No.: US 2005/0282510 A1
(43) Pub. Date: Dec. 22, 2005

(54) Linear mixer with current amplifier

(75) Inventors: Hee-mun Bang, Seoul (KR); Ick-jin Kwon, Daegu (KR); Kwy-ro Lee, Daejeon (KR); Seong-soo Lee, Suwon-si (KR); Heung-bae Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/147,206

(22) Filed: Jun. 8, 2005

(30) Foreign Application Priority Data
Jun. 21, 2004 (KR) 10-2004-0046252

(51) Int. Cl. H01Q 11/12; H04B 1/18

(52) U.S. Cl. 455/190.1; 455/311; 455/313; 455/323; 455/118

(57) ABSTRACT

A linear mixer circuit with a current amplifier has an excellent linearity by using RF open-load and an improved current amplifier. Therefore, a voltage-current converting stage and a current-voltage converting stage in a conventional mixer circuit can be omitted. Further, by using the RF open-load and the current amplifier together, a current type input signal can be transmitted as it is, and non-linearity due to the voltage-current converting stage and the current-voltage converting stage can be prevented. Furthermore, bias current of the amplifying stage and the switching stage can be separated by using the RF open-load, so that an image frequency can be filtered by the RF open-load.

### CROSS-REFERENCE TO RELATED APPLICATION

This application claims benefit under 35 U.S.C. § 119(a) from Korean Patent Application No. 2004-46252, filed on Jun. 21, 2004, the entire contents of which are incorporated herein by reference.

### BACKGROUND OF THE INVENTION

1. Field of the Invention

The present invention relates to a linear mixer, and more particularly, to a linear mixer with a current amplifier, which includes a current amplifier and a radio frequency (RF) open-load, thereby realizing a receiver circuit which has an excellent low-powered linearity.

2. Description of the Related Art

Generally, a radio receiver is provided with a low noise amplifier (LNA), a mixer, an intermediate frequency amplifier, etc., at a front end thereof.

The LNA amplifies a signal which is received at a radio receiving-end and has a very low power level due to an influence of attenuation and noise, while minimizing the noise in the signal.

The mixer operates to extract an intermediate frequency or baseband frequency signal in a system in which a signal is modulated in a carrier wave and the modulated signal is transmitted. The mixer includes a voltage-current converting stage and a frequency switching stage. A performance of the receiver circuit heavily depends on a linearity of an amplifying stage of the receiver circuit. If the amplifying stage is non-linear, undesired noise is generated.

Typically, a semiconductor amplifying device such as a bipolar junction transistor (BJT) or field-effect transistor (FET) or the like is used as the voltage-current converting stage.

The semiconductor amplifying device such as the BJT or FET or the like has a transconductance amplifying function by which an output current is controlled on the basis of an input voltage. Therefore, an input voltage signal is generally converted into an output current in an input stage of a transistor amplifier. The output current is converted into a voltage by load impedance. However, the voltage-current converting stage has a low linearity of amplification due to a non-linearity of the FET device. If the multiple voltage-current converting stages are continuously connected to each other, a linear characteristic is further deteriorated.

Accordingly, in the receiver circuit, a multi-staged mixer part has an effect on the entire linearity thereof. Particularly, the mixer includes the voltage-current converting stage and the frequency switching stage. Since the frequency switching stage is operated by a switching operation, it has a good linearity with respect to the current. A problem is raised by the non-linearity of the voltage-current converting stage.

FIG. 1 is a circuit diagram showing a structure of a conventional mixer.

Hereinafter, an operation of a conventional mixer will be described. As shown in FIG. 1, the conventional mixer comprises a voltage-current converting stage T10, a first mixer X20 and a second mixer X40.

Each of the mixers X20 and X40 is provided with a voltage-current converting stage T22, T42, a frequency switching stage S26, S44 and a current-voltage converting stage R28, R46. The voltage-current converting stage T10 is biased by a received signal so as to generate an amplified current. The amplified current is converted into a voltage value by a load of R28. The voltage is converted again into a current by biasing the voltage-current converting stage T22. Then, an intermediate frequency signal is obtained through the frequency switching stage S26 and the current-voltage converting stage R28. The same process is performed in the second mixer X40.

However, in the conventional mixer, there is a problem that the signal is distorted in each of the voltage-current converting stages T22 and T42 by the non-linearity of the transistor. In addition, there is another problem that a harmonic component is generated by the non-linearity and acted as the noise.

### SUMMARY OF THE INVENTION

An aspect of the present invention is to provide a linear mixer with current amplifier, which prevents a signal distortion and a generation of a harmonic component due to non-linearity.

To achieve this and other advantages and in accordance with the purpose of the present invention, as embodied and broadly described, a linear mixer circuit with a current amplifier includes a voltage-current converting portion for converting an input voltage signal into a first current signal having a same frequency component as the input signal and then outputting the first current signal; a RF open-load for supplying a bias voltage to the voltage-current converting portion and filtering an image frequency component from the first current signal; a first frequency conversion switching portion for coupling a first local oscillation signal LO1 and the first current signal and then outputting a second current signal having a different frequency; and a first current amplifier for amplifying the second current signal at predetermined times and outputting a third current signal.

According to an aspect of the present invention, the mixer circuit further includes a second frequency conversion switching portion for coupling a second local oscillation signal LO2 and the third current signal and then outputting a current signal having a different frequency.

According to an aspect of the present invention, the mixer circuit further includes a second current amplifier for amplifying the first current signal output from the voltage-current converting portion by second desired times and then transmitting the amplified signal to the first frequency conversion switching portion.

According to an aspect of the present invention, the first current amplifier reduces flicker noise and DC offset using a parasitic vertical NPN bipolar transistor.

According to an aspect of the present invention, the RF open-load is provided with at least one of an inductor and a capacitor so as to filter the image frequency component of the signal output from the voltage-current converting portion.

According to an aspect of the present invention, the first current amplifier is further provided with a buffer transistor so as to increase a maximum operating frequency.

According to an aspect of the present invention, the first current amplifier is further provided with a separate bypass transistor so as to reduce DC bias current.

According to another embodiment of the present invention, the linear mixer circuit is formed in a single chip.

According to yet another embodiment of the present invention, there is disclosed a radio receiver in which at least one frequency signal out of intermediate frequency and baseband frequency signal components in a radio signal is detected using the mixer circuit.

According to yet another embodiment of the present invention, there is disclosed a radio receiver in which a frequency of an input signal is converted into at least one out of an intermediate frequency and a carrier frequency using the mixer circuit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a circuit diagram showing a structure of a conventional mixer;

FIG. 2 is a block diagram of a lineal mixer with a current amplifier according to an embodiment of the present invention;

FIG. 3 is a block diagram of the linear mixer with the current amplifier according to other embodiment of the present invention;

FIG. 4 is a circuit diagram showing an example of the linear mixer with the current of FIG. 2;

FIG. 5 is a circuit diagram showing another example of the linear mixer with the current of FIG. 2;

FIG. 6 is a circuit diagram showing yet another example of the linear mixer with the current of FIG. 2;

FIG. 7 is a circuit diagram showing yet another example of the linear mixer with the current of FIG. 2;

FIG. 8 is a graph showing a simulation result of the mixer of FIG. 7; and

FIG. 9 is a graph showing the simulation result of the mixer of FIG. 7.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

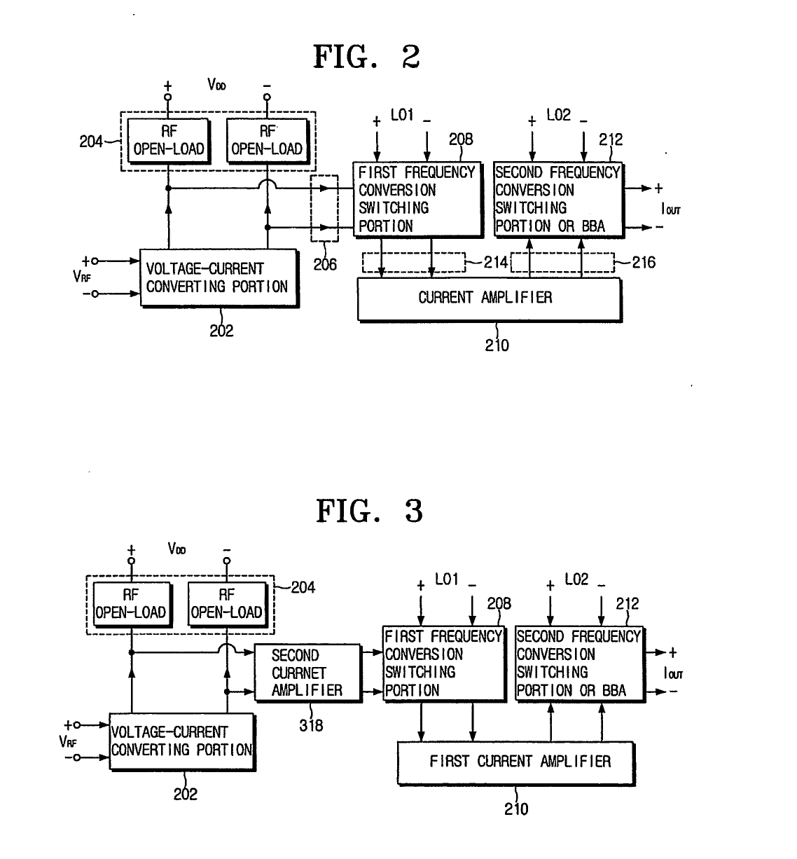

FIG. 2 is a block diagram of a linear mixer with a current amplifier according to an embodiment of the present invention.

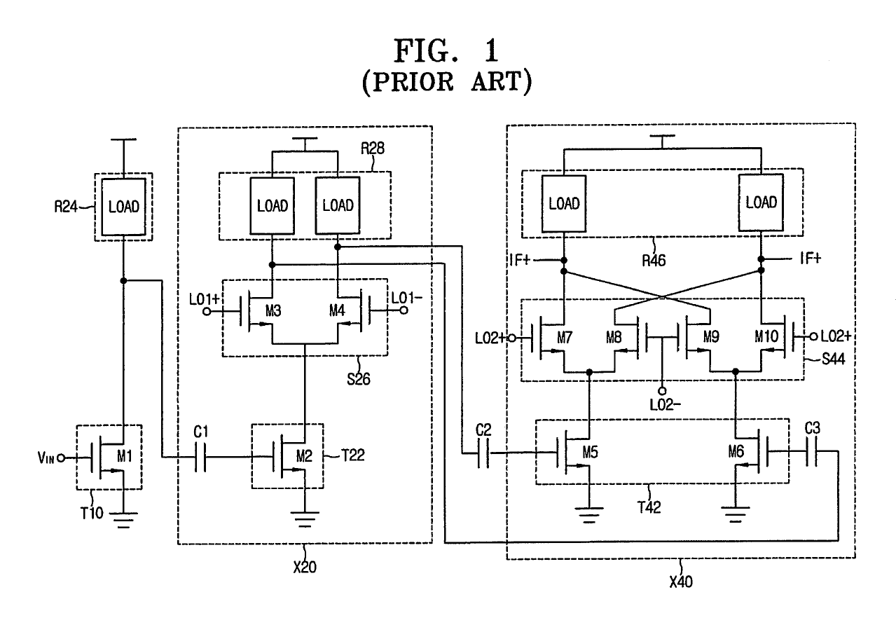

Referring to FIG. 2, a mixer circuit includes a voltage-current converting portion 202, a RF open-load 204, a first frequency conversion switching portion 208, a current amplifier 210 and a second frequency conversion switching portion 212. In comparison with the conventional mixer of FIG. 1, a general load R24, the voltage-current converting stage T22, T42 and the current-voltage converting stage R28, R46 are omitted, and the RF open-load 204 and the current amplifier 210 are further included.

The voltage-current converting portion 202 converts an input voltage signal VRF into a first current signal having the same frequency, and then the first current signal outputs through a line of a reference numeral 206.

The RF open-load 204 applies a bias voltage to the voltage-current converting portion 202, and also can separate bias current of the voltage-current converting portion 202 and the first frequency conversion switching portion 208. The RF open-load 204 includes a resistor, an inductor, and a combination of the inductor and a capacitor. An active load formed by the combination of the inductor and the capacitor, etc., can act as a filter. At this time, by a proper combination, a band pass filter (BPF) for eliminating an image frequency signal component of the input voltage signal V_{RF} included in the first current signal output from the voltage-current converting portion 202 can be realized. That is, the RF open-load 204 can serve as an image filter or an image reject filter.

The first frequency conversion switching portion 208 receives a first local oscillation signal LO1 from a first local oscillator (or a RF local oscillator) (not shown) and then mixes the signal with the first current signal output from the voltage-current converting portion 202. Thus, the first frequency conversion switching portion 208 converts the first current signal including a frequency of the input voltage signal into a second current signal including an intermediate frequency and then outputs the converted signal through a line of a reference numeral 214. Herein, the first local oscillation signal LO1 has a frequency corresponding to a difference between a frequency of a carrier wave including the input voltage signal and the intermediate frequency.

The current amplifier 210 receives the second current signal and generates a third current signal amplified at predetermined times while keeping a corresponding frequency signal component, and then outputs the third current signal through a line of a reference numeral 216. The current amplifier 210 has two current mirrors. It is possible to amplify the signal at predetermined times by regulating gains of the current mirrors. Therefore, the second current signal can be amplified at predetermined times. The gain can be regulated by adjusting a rate of width/length of the transistor included in the two current mirrors in a semiconductor fabricating process

The second frequency conversion switching portion 212 receives the third current signal having the intermediate frequency from the current amplifier 210. The second frequency conversion switching portion 212 receives the second local oscillation signal LO2 from the second oscillator (or RF local oscillator) (not shown), and then generates an output current signal including a baseband frequency component. Herein, the second local oscillation signal LO2 has a frequency corresponding to a difference between the intermediate frequency and the baseband frequency.

The first and second frequency conversion switching portions 208 and 212 can use a bipolar junction transistor (BJT), an N-type MOSFET or P-type MOSFET. Furthermore, in order to solve an isolation problem of an input/output terminal of the second frequency conversion switching portion 212, a Single balanced mixer (SBM) and a Double balanced mixer (DBM) can be used.

The output current signal passing through the second frequency conversion switching portion 212 is converted into a baseband voltage signal, which is substantially required in the RF receiver circuit, etc., by a current-voltage converting portion (not shown).

However, in the case of a direct conversion receiver, the second frequency conversion switching portion 212 can be omitted. In this case, since the direct conversion receiver is a radio transmitting and receiving type which does not use the intermediate frequency, it needs only one frequency conversion switch for eliminating only the carrier wave from the input voltage V_{RF}. The third current signal can be converted into the output voltage by the current-voltage converting portion (not shown) and then input to a baseband analog circuit (not shown).

According to an aspect of the present invention the mixer circuit converts the input signal into the current signal in the voltage-current converting portion 202, and then performs the signal processing operations while the signal is continuously kept in a state of the current signal. Therefore, the non-linearity of the voltage-current converting stage can be prevented. Furthermore, the first frequency conversion switching portion 208 can separate the bias current of the voltage-current converting portion 202 and the first frequency conversion switching portion 208 using a folded mixer structure separated from the voltage-current converting portion 202, thereby obtaining the respective optimum bias current.

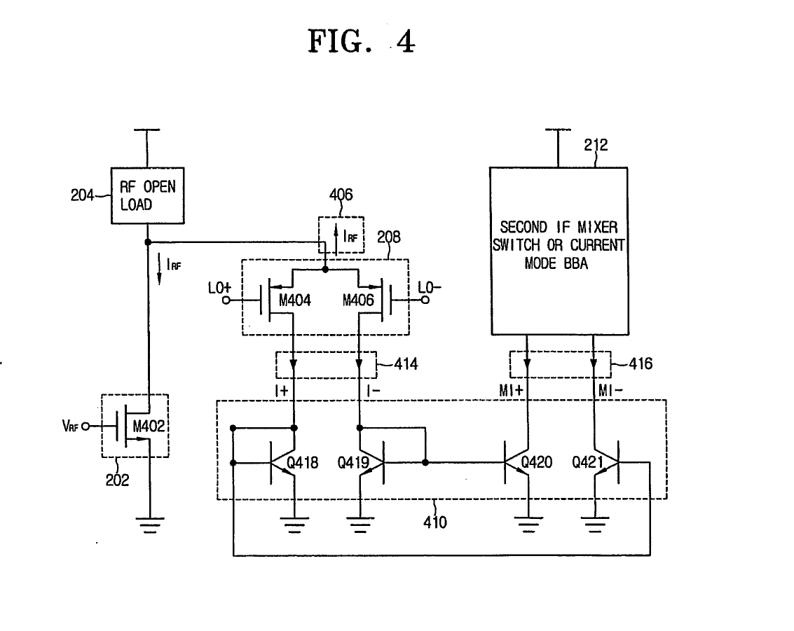

FIG. 3 is a block diagram of the linear mixer with the current amplifier according to other embodiment of the present invention. In the mixer circuit of FIG. 3, the first current signal output from the voltage-current converting portion 202 is amplified at predetermined times before being input to the first frequency conversion switching portion 208.

A second current amplifier 318 amplifies the first current signal and input the signal to the first frequency conversion switching portion 208. Therefore, a second current signal output from the first frequency conversion switching portion 208 can be previously amplified. Since the signal that the receiver circuit seeks to obtain out of the current signals output from the first and second frequency conversion switching portions 208 and 212, is not the first current signal input to the first frequency conversion switching portion 208 or the signal frequency of the first local oscillator, but an intermodulated signal, an intensity of the signal is reduced. Therefore, an amplifying circuit is essentially needed.

The second current amplifier 318 keeps the frequency of the first current signal, and amplifies the signal at predetermined times and then transmits the amplified signal to the first frequency conversion switching portion 208.

FIG. 4 is a circuit diagram showing an example of the linear mixer with the current of FIG. 2. Referring to FIGS. 2 to 4, the mixer according to the present invention will be described in detail. The same reference numbers will be used throughout the drawings to refer to the same or like parts and the description thereof will be omitted.

The voltage-current converting portion 202 uses an N-type MOSFET (hereinafter, called as “NMOS) M402. The input voltage VRF is converted into a first current signal 406 by the NMOS M402.

The first frequency conversion switching portion 208 is the same as the first frequency conversion switching portion 208 of FIG. 2, and is formed into a single balanced structure using a P-type MOSFET (hereinafter, called as “PMOS”) M404, M406.

A first current amplifier 410 includes transistors Q418, Q419, Q420 and Q421. The transistors Q418 and Q419 form a first current mirror, and the transistors Q420 and Q421 form a second mirror. By regulating gains of the first and second current mirrors, it can realize a current amplification by predetermined times.

A parasitic vertical NPN BJT (hereinafter, called as “V-NPN BJT”) in a CMOS process is used as each of the transistors Q418, Q419, Q420 and Q421. Thus, a flicker noise (or 1/f noise) which is an inherent noise of an active device is very small in comparison with a general MOSFET, and a matching characteristic of the device can be improved. This is more effective in a direct conversion receiver which does not have the second frequency conversion switching portion.

The flicker noise and DC offset is a serious problem in the direct conversion receiver. In a conventional direct conversion receiver, it is difficult to realize an integrated circuit due to the DC offset problem by a leakage of the local oscillator, a mismatching problem between In-phase/Quadrature-phase circuits, etc.

To this end, the BJT, which has a very small flicker noise comparing to the MOSFET and also has an excellent matching characteristic between devices, is used. Furthermore, there is used the V-NPN BJT which can obtain by using a deep well in a standard triple well CMOS process. Therefore, it has a good high frequency performance enough to be used in a circuit of a few GHz, and since the devices are also isolated from each other, it can be applied to a high-speed IC. Further, the V-NPN BJT has a very small flicker noise in comparison with a MOS transistor and has a good matching characteristic between the devices.

The first current amplifier 410 using the V-NPN BJT can be applied to the first current amplifier 210 in a circuit of FIG. 3.

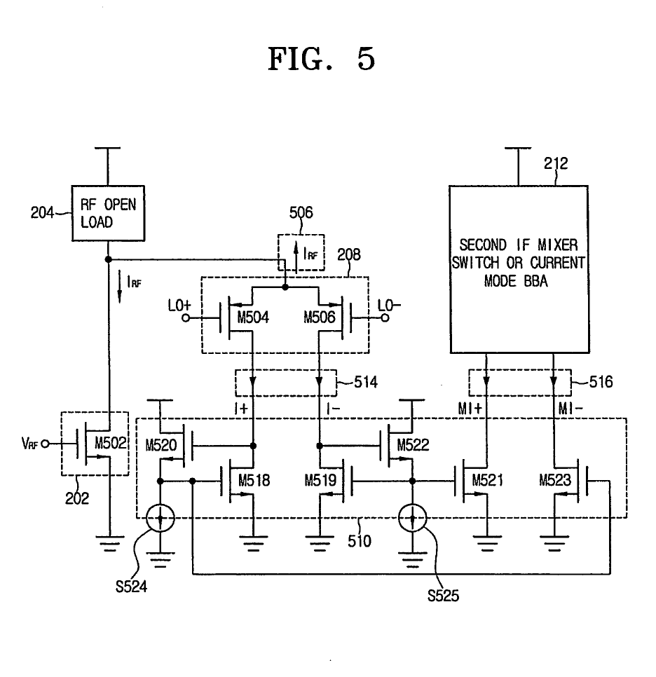

FIG. 5 is a circuit diagram showing another example of the linear mixer with the current of FIG. 2.

A circuit of FIG. 5 has the same structure as that of FIG. 4. However, the circuit of FIG. 5 comprises a current amplifier 510 using a buffered current mirror further including a buffer transistor, corresponding to the current amplifier 410 of FIG. 4. Since a bandwidth of a mixer circuit of FIGS. 2 and 3 is determined by the current amplifier 210, the current amplifier 510 in the circuit of FIG. 5 uses the buffered current mirror having a wide bandwidth so as to obtain a high maximum operating frequency.

The current amplifier 510 is provided with M518, M519, M520, M521, M522 and M523 which are formed into the NMOS. The current amplifier 510 has to have a small capacitance in order to have a wide bandwidth. A gate capacitance of the M518, M523 is not seen by the buffer M520, and a gate capacitance of the M519, M521 is not seen by the buffer M522. A gate capacitance of the buffer M520, 522 can be formed to be smaller than the M518, M519, M521 and M523. Furthermore, although a surface area of the M521 and M523 is increased in a fabricating process so as to amplify the current signal at predetermined times, it has no influence on the bandwidth. Therefore, the maximum operating frequency of the current amplifier 510 is increased.

The buffer structure of the current amplifier 510 of FIG. 5 can be applied to the first current amplifier 210 in the circuit of FIG. 3, and also can realize a structure of the same buffered current mirror using the V-NPN BJT of FIG. 4. In addition, the structure of a generally well-known buffered current mirror can be used.

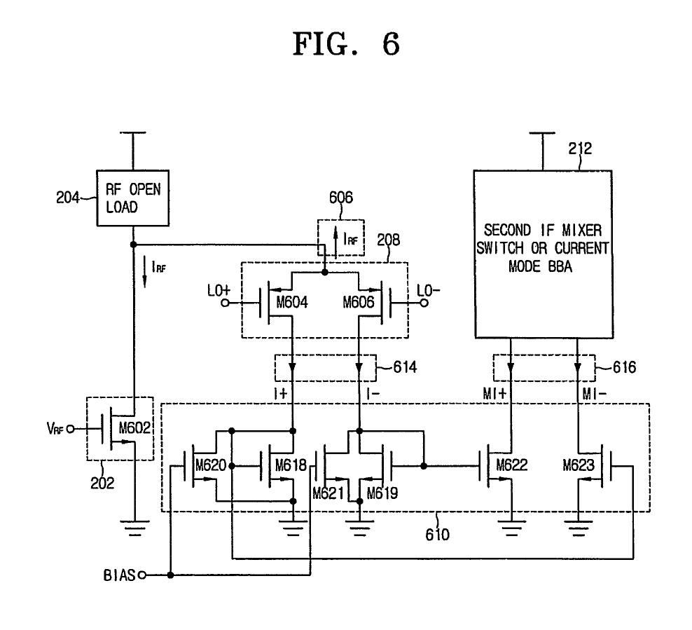

FIG. 6 is a circuit diagram showing yet another example of the linear mixer with the current of FIG. 2. In the case that the current mirror is used in the current amplifier 210 of FIG. 2, there is a scaling problem in that DC bias current is also amplified, etc. In order to solve the problem, a current amplifier 610 of FIG. 6 can be used to reduce the DC bias current.

The current amplifier 610 includes M618, M619, M620, M621, M622 and M623 which are formed into the NMOS. The M620 and M621, which are bypass transistors, can eliminate the DC current of the current mirror. The bypass transistors M620 and M621 are disposed in parallel to control the current of the two current mirrors, thereby reducing the DC component of the DC current. The bypass transistors M620 and M621 bypass a desired intensity of current corresponding to a bias voltage regulation thereof.

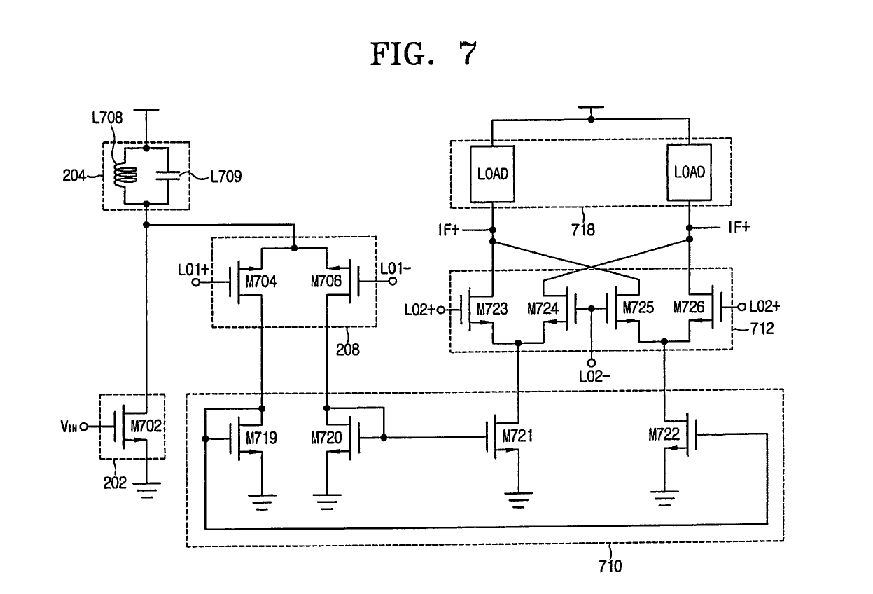

FIG. 7 is a circuit diagram showing yet another example of the linear mixer with the current of FIG. 2. A current amplifier 710 includes M719, M720, M721 and M722. A rate of Width/Length (W/L) of a first current mirror formed by the M719 and M720 and a second current mirror formed by the M721 and M722 is set to N.

The mixer includes a second frequency conversion switching portion 712 using a double balanced structure, and a current-voltage converting portion 718.

The current-voltage converting portion 718 converts an output current signal of the second frequency conversion switching portion 712 into a voltage signal before transmitting to a baseband analog circuit (not shown).

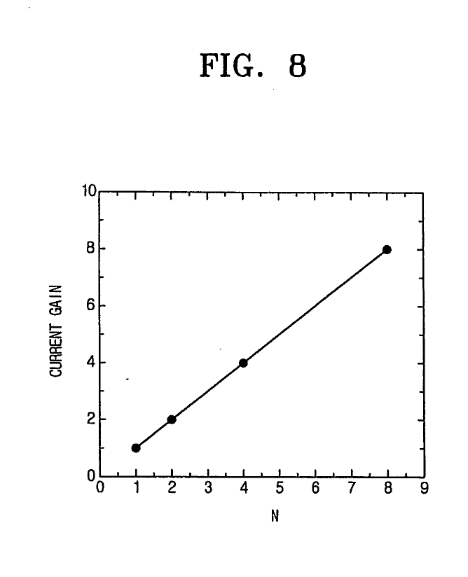

FIG. 8 is a graph showing a simulation result of the mixer of FIG. 7. A transverse axis of the graph is the N which is the rate of W/L of the two current mirrors of the current amplifier 710. A longitudinal axis of the graph is a current gain, i.e., an amplification factor with respect to the N. As shown in FIG. 8, the amplification factor is changed linearly.

Further, when measuring a third input intercept point value (IIP3) which indicates a performance of the receiver circuit, the IIP3 value is remarkably increased by the linearity.

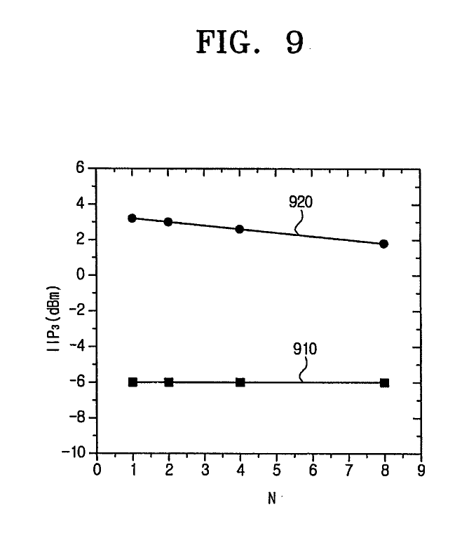

FIG. 9 is a graph showing the simulation result of the mixer of FIG. 7. In FIG. 9, a reference numeral 910 is an IIP3 value in a conventional structure, and 920 is an IIP3 value in the structure of the embodiment of FIG. 7.

Up to now, the mixer in the receiver circuit is described as the preferred embodiment of the present invention. However, the embodiments of FIGS. 2 through 7 are not limited to the receiver circuit, and can be applied to a transmitter circuit. In this case, a voltage signal input to the voltage-current converting stage is a baseband signal, and a current signal output from the second frequency conversion switching portion comprises a signal which is modulated into a carrier frequency.

According to the mixer of the present invention, as described above, the non-linearity by the voltage-current converting stage and the current-voltage converting stage can be eliminated. Further, an actual circuit of the mixer using the current mirror is provided, thereby having effects as follows:

Firstly, the DC offset and the flicker noise in a direct conversion receiver can be reduced by using the V-NPN BJT.

Secondly, the mixer having a high maximum operating frequency can be realized by using the buffer transistor.

Thirdly, the mixer which can prevent the scaling problem of the DC bias current can be realized by using the current mirror.

Furthermore, the mixer of the present invention can normally transmit the current but filter an image frequency by using RF open-load like an inductance or capacitor load, etc.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A linear mixer circuit with a current amplifier, comprising:
a voltage-current converting portion converting an input voltage signal into a first current signal having a same frequency component as the input signal and then outputting the first current signal;
a RF open-load supplying a bias voltage to the voltage-current converting portion and filtering an image frequency component from the first current signal;
a first frequency conversion switching portion coupling a first local oscillation signal and the first current signal and then outputting a second current signal having a different frequency of the first current signal; and
a first current amplifier amplifying the second current signal by predetermined times and outputting a third current signal.

2. The mixer circuit as claimed in claim 1, further comprising a second frequency conversion switching portion for coupling a second local oscillation signal and the third current signal and then outputting a current signal having a different frequency.

3. The mixer circuit as claimed in claim 1, further comprising a second current amplifier for amplifying the first current signal output from the voltage-current converting portion at predetermined times and then transmitting the amplified signal to the first frequency conversion switching portion.

4. The mixer circuit as claimed in claim 1, wherein the first current amplifier reduces flicker noise and DC offset using a parasitic vertical NPN bipolar transistor.

5. The mixer circuit as claimed in claim 1, wherein the RF open-load is provided with at least one of an inductor and a capacitor so as to filter the image frequency component of the signal output from the voltage-current converting portion.

6. The mixer circuit as claimed in claim 1, wherein the first current amplifier further comprises a buffer transistor to increase a maximum operating frequency.

7. The mixer circuit as claimed in claim 2, wherein the first current amplifier further comprises a buffer transistor to increase a maximum operating frequency.

8. The mixer circuit as claimed in claims 3, wherein the first current amplifier further comprises a buffer transistor to increase a maximum operating frequency.

9. The mixer circuit as claimed in claim 4, wherein the first current amplifier further comprises a buffer transistor to increase a maximum operating frequency.

10. The mixer circuit as claimed in claim 5, wherein the first current amplifier further comprises a buffer transistor to increase a maximum operating frequency.

11. The mixer circuit as claimed in claim 1, wherein the first current amplifier further comprises a separate bypass transistor to reduce DC bias current.

12. The mixer circuit as claimed in claim 2, wherein the first current amplifier further comprises a separate bypass transistor to reduce DC bias current.

13. The mixer circuit as claimed in claim 3, wherein the first current amplifier further comprises a separate bypass transistor to reduce DC bias current.

14. The mixer circuit as claimed in claim 4, wherein the first current amplifier further comprises a separate bypass transistor to reduce DC bias current.

15. The mixer circuit as claimed in claim 5, wherein the first current amplifier further comprises a separate bypass transistor to reduce DC bias current.

16. The mixer circuit as claimed in claim 1, wherein the linear mixer circuit is formed in a single chip.

17. The mixer circuit as claimed in claim 11, wherein the linear mixer circuit is formed in a single chip.

18. The mixer circuit as claimed in claim 12, wherein the linear mixer circuit is formed in a single chip.

19. The mixer circuit as claimed in claim 13, wherein the linear mixer circuit is formed in a single chip.

20. The mixer circuit as claimed in claim 14, wherein the linear mixer circuit is formed in a single chip.

21. The mixer circuit as claimed in claim 15, wherein the linear mixer circuit is formed in a single chip.

22. A radio receiver for receiving a wireless signal by detecting at least one frequency signal out of intermediate frequency and baseband frequency signal components in a radio signal using the mixer circuit claimed in claim 1.

23. A radio receiver for receiving a wireless signal by detecting at least one frequency signal out of intermediate frequency and baseband frequency signal components in a radio signal by using the mixer circuit claimed in claim 11.

24. A radio receiver for receiving a wireless signal by detecting at least one frequency signal out of intermediate frequency and baseband frequency signal components in a radio signal using the mixer circuit claimed in claim 12.

25. A radio receiver for receiving a wireless signal by detecting at least one frequency signal out of intermediate frequency and baseband frequency signal components in a radio signal using the mixer circuit claimed in claim 13.

26. A radio receiver for receiving a wireless signal by detecting at least one frequency signal out of intermediate frequency and baseband frequency signal components in a radio signal using the mixer circuit claimed in claim 14.

27. A radio receiver for receiving a wireless signal by detecting at least one frequency signal out of intermediate frequency and baseband frequency signal components in a radio signal using the mixer circuit claimed in claim 15.

28. A radio transmitter for converting a frequency of an input signal into at least one out of an intermediate frequency and a carrier frequency using the mixer circuit claimed in claim 1, so that the input signal is converted into a radio output signal.

29. A radio transmitter for converting a frequency of an input signal into at least one out of an intermediate frequency and a carrier frequency using the mixer circuit claimed in claim 11, so that the input signal is converted into a radio output signal.

30. A radio transmitter for converting a frequency of an input signal into at least one out of an intermediate frequency and a carrier frequency using the mixer circuit claimed in claim 12, so that the input signal is converted into a radio output signal.

31. A radio transmitter for converting a frequency of an input signal into at least one out of an intermediate frequency and a carrier frequency using the mixer circuit claimed in claim 13, so that the input signal is converted into a radio output signal.

32. A radio transmitter for converting a frequency of an input signal into at least one out of an intermediate frequency and a carrier frequency using the mixer circuit claimed in claim 14, so that the input signal is converted into a radio output signal.

33. A radio transmitter for converting a frequency of an input signal into at least one out of an intermediate frequency and a carrier frequency using the mixer circuit claimed in claim 15, so that the input signal is converted into a radio output signal.

34. A method of amplifying a current, comprising:
receiving an input voltage;
converting the input voltage into a first current signal to eliminate a carrier wave from the input voltage; and
converting the first current signal into an output voltage.

35. A method of claim 34, further comprises:
converting the first current signal into a second current signal having a different frequency than the first current signal.

36. A linear mixer circuit with a current amplifier, comprising:
a voltage-current converting portion converting an input voltage signal into a first current signal having a same frequency component as the input voltage signal and then outputting the first current signal;
a first frequency conversion switching portion coupling a first local oscillation signal and the first current signal and then outputting a second current signal having a different frequency; and
a first current amplifier amplifying the second current signal at predetermined times and outputting a third current signal.

37. The linear mixer circuit as claimed in claim 36, further comprising a second frequency conversion switching portion coupling a second local oscillation signal and the third current signal and then outputting a current signal having a different frequency.
